(19) United States
(12) Patent Application Publication
(10) Pub. No.: US 2008/0080341 A1
(43) Pub. Date: Apr. 3, 2008

(54) Portable Audio and/or Video Device with a Hard Disk and a Shock Resistant Memory

(75) Inventor: Jasper Emile Joost Vervoort, Hong Kong (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,074

(22) PCT Filed: Aug. 31, 2005
(86) PCT No.: PCT/IB05/52855

§ 371 Date: Mar. 12, 2007

(30) Foreign Application Priority Data
Sep. 10, 2004 (EP) 04104368.8

(51) Int. Cl. G11B 20/10

(52) U.S. Cl. 369/47.11

(57) ABSTRACT

(A portable device (1) for processing data (D) is equipped with first memory means (2) for storing said data (D), wherein the first memory means (2) are arranged to be stopped providing said data (D) to be processed, and comprises second memory means (3) for storing a portion of said data (D) in order to provide the stored data for processing while the first memory means (2) are stopped providing said data and comprises interface means (7) for receiving a first command provided by a user for stopping said first memory means (2) providing data (D) and for producing a stop signal (S) in response to the received first user command and comprises processing means (4) for receiving the stop signal (S) and for stopping said first memory means (2) providing data (D) in response to the received stop signal (S) and for processing data (D) provided by the second memory means (3) while the first memory means (2) are stopped providing data (D).

### FIELD OF THE INVENTION

The invention relates to a portable device for processing data, the device comprising first memory means and second memory means for providing stored data.

The invention further relates to a method of processing data in a portable device, which device comprises first memory means and second memory means for providing stored data.

### BACKGROUND OF THE INVENTION

From the document US 2002/0083280 A1 it is known a device that is realized by a personal computer (PC). The PC comprises first memory means, which are realized by a hard disk for storing data. The hard disk, when in operation, can be stopped by applying a stop trigger signal to it. This causes the hard disc to be suspended and stopped, respectively, from operation, which means that the read/write heads are driven into a parking position outside of the outer diameter of rotatable disks that store the data and the disks are stopped from spinning. In this state the hard disk is relatively well protected from being damaged due to vibration or mechanical shock. However, also the read out of stored data is inhibited or interrupted during this state.

The PC further comprises second memory means, which are realized by a non-volatile solid state memory. The second memory means are provided for storing at least a portion of the data stored in the hard disk and are used for providing these data for processing during a time duration during which the hard disk is suspended from operation.

The PC further comprises detection means for detecting whether or not the PC is moving. The conditions whether the PC is regarded to be moving is whether or not an AC power line, a LAN cable, and a telephone line are connected to the PC respectively. In addition a movement detector can be provided for detecting acceleration or a force that affects the PC. According to the detection result the PC can be used in a first mode of operation when it is installed fixedly and in a second mode of operation when it is moving. In the first mode of operation the PC utilizes the hard disc and all data are available. In the second mode of operation the PC utilizes the solid-state memory and only a reduced set of data is available.

In a common work environment the PC is normally connected to the AC power lines and to the LAN. A power management unit or software guarantees that the power is provided to all the components of the PC. Hence the PC is operatable in its first mode of operation. As soon as the PC is not any longer connected to the AC power lines said power management unit or software will deactivate the hard disc after a predetermined time or after having detected that the PC was not used during a predetermined time in order to save energy that is now provided via a battery or an accumulator. Typically also other components of the PC are switched of from being supplied with power at once or one after the other and the PC will finally reach a dormant status. Pressing a power-on button of the PC typically does waking up the PC. Now the detection means detect that the PC is in a moving condition and only the second mode of operation is allowed for processing date. Hence the PC is now only operated in its second mode of operation and does utilize the solid-state memory only. This provides the advantage that the hard disk is protected from being damaged while the detection means do not detect that the PC is installed fixedly.

With the known device, however, it has proved to be a disadvantage that the use of the second mode of operation is only possible under control of the software or hardware of the PC.

### OBJECT AND SUMMARY OF THE INVENTION

It is an object of the invention to provide a device of the type defined in the opening first paragraph and a method of the type defined in the second paragraph, in which the disadvantages defined above are avoided.

In order to achieve the object defined above, with a device according to the invention characteristic features are provided so that a device according to the invention can be characterized in the way defined below, that is:

Portable device for processing data, the device comprising first memory means provided for storing said data, said first memory means are arranged of being stopped providing said data to be processed; and second memory means provided for storing at least a portion of said data, said second memory means being arranged to provide said portion of said data while the first memory means are stopped providing said data, and processing means arranged to receive a stop signal and arranged to stop the first memory means providing said data in response to the received stop signal and arranged to process data provided by the second memory means while the first memory means are stopped providing data, and interface means arranged to interface with a user for the purpose of receiving a first user command and to produce said stop signal in response to the received first user command and to provide said produced stop signal to the processing means.

In order to achieve the object defined above, with a method according to the invention characteristic features are provided so that a method according to the invention can be characterized in the way defined below, that is:

Method of processing data in a portable device, which device comprises first memory means and second memory means for providing stored data, wherein said first memory means are arranged of being stopped providing said data to be processed, said method comprising the steps of receiving a first user command by the aid of interface means of the device, and producing a stop signal for stopping the first memory means providing data in response to the received user command, and providing said produced stop signal to processing means of the device, which processing means are arranged to receive said stop signal and to stop the first memory means providing said data in response to the received stop signal, and processing the data provided by the second memory means with the processing means while the first memory means being stopped providing said data.

The characteristic features according to the invention provide the advantage that a user can decide upon his/her intention that the first memory means, e.g. a hard disk that cannot withstand relatively high levels of vibrations or mechanical shock effects, shall be protected and that the device shall immediately stop operating of the first memory means and utilize the second memory means for data processing. In particular the second memory means are arranged for withstanding higher levels of vibration or mechanical shock detects as said first memory means. This allows using a hard disk that is commonly used in standard PCs also in a portable audio and/ or video reproduction and/or recording device during sportive activities, which activities are typically associated with heavy vibrations or mechanical shock effects. As soon as a user may realize that he/she is approaching such a situation that may cause damage to the hard disk he/she can deactivate the hard disk on demand and can relatively be sure that the hard disc will not be damaged. In addition this also prolongs the lifetime of such hard disks significantly such that the user will enjoy the use of the device for a relatively long time in comparison to prior art portable devices having their hard disk permanently in operation.

The measures as claimed in claim 2 and claim 6, respectively, provide the advantage that for example a user can pre-determine how many pre-defined portions of data he/she wishes to have copied into the second memory means in order to have them available while the first memory means are stopped providing data. In a typical situation of use the user will adjust the number of pre-defined portions of data according to an estimated duration of the activities that provoke said vibrations or mechanical shock effects.

In a solution according to the invention there may be provided that the first memory means will remain stopped providing data until a re-boot (re-start) of the device takes place, e.g. until the power supply of the device is witched off and on again. This may guarantee that the first memory means are not re-activated accidental during said sportive activities. However, it has proved to be particularly advantageous if the measures of claim 3 and claim 7, respectively are provided. This achieves the advantage that a user does not have to re-boot the device each time he/she wants to have access to all the data or pre-defined portions of data that are stored on the first memory means. Re-activating of the first memory means may for example be done automatically after a pre-determined variable duration of time or after a fixed duration in time has elapsed. In a further embodiment also sensors for detecting that the vibrations or mechanical shock effects have been faded may be provided.

The measures as claimed in claim 4 and claim 8, respectively, provide the advantage that a user does not have to wait until an operation system of the device re-activates the first memory means for providing stored data. Advantageously the user can decide on his/her demand when the first memory means shall become available for providing data after they have been stopped for being protected against vibrations or mechanical shock effects.

The measures as claimed in claim 5 and claim 10, respectively, provide the advantage that the lifetime of portable digital consumer products that is associated to shock impact can significantly increase and a user can actively protect the device without having the fear of preventing too much shock impact on the device.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 shows a device according to the invention in the form of a block circuit diagram.

### DESCRIPTION OF EMBODIMENTS

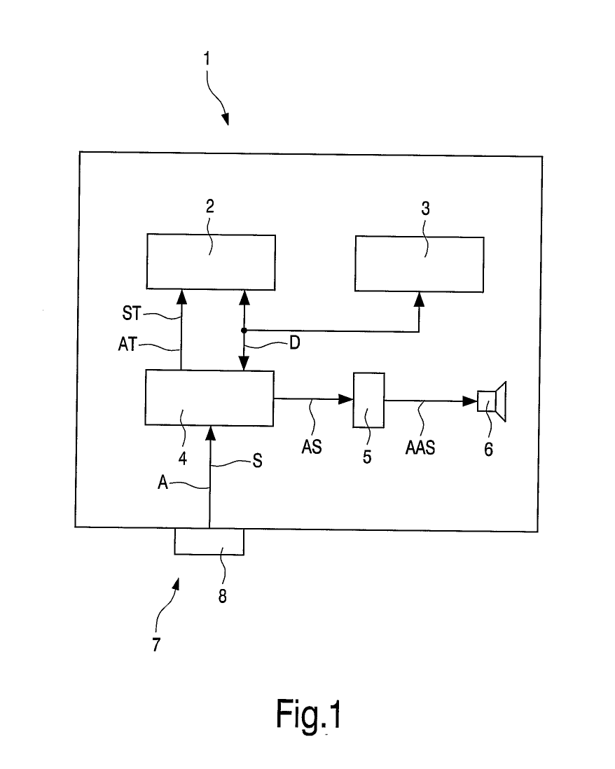

The device shown in FIG. 1 is a device for processing data. In the present case it realizes a so-called MP3 player 1 for reproducing audible signals that are digitally coded according to an MPEG coding scheme, which scheme is well known in prior art. The MP3 player 1 comprises first memory means that are realized by a hard disk 2, which has a sufficient large storage capacity for storing a few thousand audio songs. The hard disk 2 is the main storage for storing data D and for providing said stored data D for being processed within the MP3 player.

Although interfacing means for interfacing with another device are not explicitly shown in FIG. 1, a person skilled in the art will understand that such an MP3 player 1 has interfacing means for interfacing with another device, e.g. with a personal computer, in order to transfer data D that represent audio songs from the PC to the PM3 player 1 for storing them with the hard disk 2. Also a power switch for switching on and off the power source, e.g. a battery, of the MP3 player 1 is available but not shown in FIG. 1.

Switching on the power source causes the hard disk 2 to be activated. Therefore the data carrying disks (not shown in FIG. 1) of the hard disk 2 are brought into rotation and the read/write heads (not shown in FIG. 1) of the hard disk 2 are released from a parking position, in which they are parked when the power source is switched off or in which they are parked when the hard disk enters a power save mode, which is for exampled triggered by not requesting data D for a longer period in time. Having parked the heads in the parking position the hard is relatively well protected against damages due to vibrations or mechanical shock effects. Such a behavior of the hard disk is known in prior art.

In addition to the hard disk 2 the MP3 player 1 further comprises second memory means that are realized by a solid-state semiconductor memory 3 of the non-volatile type. Advantageously the memory 3 is the secondary memory of the MP3 player 1 that will be used during periods of heavy vibrations or mechanical shock effects, during which the hard disk is not available for providing data, as will be explained later.

The MP3 player 1 further comprises processing means 4 that are arranged to control the flow of data D to and from the hard disk 2 and that are arranged for processing of data D in general. The processing means 4 are in particular arranged to request data D from the hard disk 2 and to receive data D provided by the hard disk 2 and to process the received data D according to the MPEG standard in order to provide an electrical analogue signal AS that represents audible information, e.g. a song. The MP3 player 1 further comprises an amplifier 4 for amplifying the analogue signal AS and for providing an amplified analogue signal AAS. Connected to the amplifier 5 is a loudspeaker 6 for producing an audible audio signal on the basis of the amplified analogue signal AAS. The processing means 4 are also arranged to request or more precisely to read out data D from the memory 3 and to process these data D in analogy to the data D received from the hard disk 2.

The MP3 player 1 further comprises interfacing means 7 for interfacing with a user, which means for providing status information concerning the play back status of songs or for providing selection options for selecting one song or more songs to be played back out of an inventory list. Also other settings like volume and loudness or equalizer setting may be provided via the interface means 7. In the present case the interface means are realized by a liquid crystal (LCD) display and play control buttons for selecting and/or activating or deactivating features relating to the play back functionalities of the MP3 player 3. The LCD display and the play control buttons, which are considered to be known in prior art, are not explicitly shown in FIG. 1.

Advantageously the interface means further comprise a “shock lock/unlock” button 8. The button 8 is provided for receiving a first user command, which is the so-called “stop command” for stopping the hard disk 2 from providing data D that can be processed by the processing means 4. The same button 8 is also provided for receiving a second user command, which is the so-called “activation command” for re-activating the hard disk 2 for providing data D that can be processed by the processing means 4 after it has been stopped by the same button 8 before.

The button 8 is arranged to be pressed and being arrested in its pressed position. In this position a contact (not shown in FIGURE) of the button is closed and a stop signal S is produced and provided (send or sense-able) to the processing means 4.

The processing means 4 are arranged to receive the stop signal S. The processing means 4 are further arranged for copying a pre-determined portion of data D, that represents for example twenty (20) songs form the hard disk 2 to the memory 3 before stopping the hard disk 2, which is triggered by receiving the stop signal at the processing means 4. The processing means 4 are further arranged for producing a stop trigger signal ST in response to the received stop signal S after having copied the portion of data D and to deliver the stop trigger signal ST to the hard disk 2, which triggers the hard disk 2 to stop or interrupt its operation and to move the read heads into the parking position as explained above. Consequently the processing means 4 are arranged to stop the first memory means, which are realized by the hard disk 2, providing data D. Furthermore the processing means 4 are arranged to switch over from processing data D provided by the hard disk 2 to request data D from the memory 3 and, while the hard disk 2 is stopped, to process data D received from the memory 3 in the same way as they would have been received from the hard disk 2.

The button 8 is further arranged to be pressed again and being released from the arrested position. In its released position the contact (not shown in FIG. 1) of the button is open and an activation signal A is produced and provided (send or sense-able) to the processing means 4.

The processing means 4 are arranged to receive the activation signal A. The processing means 4 are further arranged for producing an activation trigger signal AT in response to the received activation signal S and to deliver the activation trigger signal AT to the hard disk 2, which triggers the hard disk 2 to re-activate its operation, which means that the read/write heads are moved out of the parking position and that the discs are spinned. Consequently the processing means 4 are arranged for re-activating of the stopped first memory means, which are realized by the hard disk 2, providing data D. Furthermore the processing means 4 are arranged to switch over from processing data D provided by the memory 3 to request data D from the hard disk 2 and to process data D received from the hard disk 2 in the same way as they have been received before the hard disk 2 was stopped or interrupted respectively.

In the following the operation of the MP3 player 1 is explained in more details. It is to be assumed that the MP3 player 1 has stored a number of one thousand (1000) songs on its internal hard disk 2 and a user goes for mountain biking while listening to the stored songs. As soon as the user reaches a downhill passage he decides to protect the hard disk from being damaged by pressing the button 8. This initiates the execution of steps of a method of processing data D in the portable device 1 according to the invention.

According to this method the user triggered stop command is received by the aid of the user interface 7, in particulate by the button 8 of the user interface 7. In response to the received user command the stop signal S for stopping the hard disk providing data D is produced and provided to processing means 4. In a next step of said method the processing means copy a pre-determined portion of data representing, e.g. 20 songs, from the hard disk 2 to the memory 3. In a next step of said method the processing means provide a stop trigger signal ST to the hard disk 2 that triggers the hard disk 2 to stop or interrupt its operation. Consecutive or parallel in time to this last step of said method the processing means 4 switch over from processing data D provided by the hard disk 2 to process data D provided by the memory 3 as they would have been provided by the hard disk 2.

After having finalized the downhill passage the biker would on his own demand decide that the danger is over of having heavy mechanical impact on the hard disk 2 that may cause the hard disk being damaged. He will press the button 8 again in order to have all songs available. This triggers a next step of execution of said method, because the user has provided the activation command. According to said method the user triggered activation command is received by the aid of the interface means 7, in particular by the aid of the button 8. In response to the received user command the activation signal A is produced and provided to the processing means 4. In a next step of said method the processing means 4 produce the activation trigger signal AT that is send to the hard disk 2. According to a further step of said method the hard disk 2 is activated in response to the received activation trigger signal AT. Consecutive to this step or parallel in time the processing means 4 switch over from processing data D provided by the memory 3 to processing data D provided from the hard disk 2. Consequently the user can again audibly enjoy all the songs stored on the hard disk 2.

It can be mentioned that the device 1 according to the invention can be arranged for reproducing videos. In addition the device may also be arranged for recording audio signals or video signals or combinations of both. Furthermore it can be mentioned that not only MPEG coding/encoding schemes may be applied but also other well known or future schemes are applicable in this connection. Further more it can be mentioned that the device can be arranged for processing data representing text or numbers, like it is the case for text documents or data sheets used in e.g. business and economics or in private. In general all kind of data representing any information can be considered. As a further example also navigation date and the like can be mentioned.

It can be mentioned that the first memory means can be realized by the aid of a disk drive for accessing data stored on an optically readable data carrier like a compact disk (CD) or a digital versatile disk (DVD). Stopping the first memory means from providing data would mean in both cases that the disk is locked or blocked form being rotated and the optical pick up unit is parked in a shock protected position.

It can be mentioned that any storage device that has a higher acceptance with respect to vibrations or mechanical shock effects as the hard disk 2 and that does not run the risk of being damaged by such mechanical impacts can realize the memory 3. In this connection for example a magnetic random access memory (MRAM) can be mentioned in addition to the already mentioned semiconductor memory 3.

Although the button 8 has been described as main part of the interface 7 for interfacing with a user, it can be mentioned that the interface means 7 can be arranged to receive audible commands for controlling the activity of the hard disk 2. Also touch screens or other embodiments of tactile sensors may be considered instead of the button 8.

Furthermore it can be mentioned that the change over between the hard disk 2 and the memory 3 for providing data D that can be processed can be indicated by two different sounds, each being characteristic for one storage.

For those skilled in the art it is clear that the processing means 4 can be split up into two parts, namely a first part dedicated for controlling the activity of the hard disk 2 dependent on the user interaction with respect to the button 8 and a second part dedicated for processing the data provided either by the hard disk 2 or by the memory 3. In this configuration the first part can be either separated from the hard disk 2 or can be a part of the hard disk 2. Typically the second part will not be incorporated in the hard disk 2. Considering a common bus system to which the data are flushed by the first part of the processing means 4, which first part may also have data D processing properties incorporated for doing so, the second part for processing the data according to the MPEG standard does not even have to know from which storage the data are provided. However, it can be advantageous to inform also the second part of the processing means 4 about the source from which the data are provided in order to have always the maximum system consistence available.

It can be mentioned that instead of copying a pre-determined number of songs from the first memory 2 to the second memory 3 it may be provided that a random number of songs that fit into the memory size of the second memory means 3 may be copied. Also a random selection of these songs may be possible.

It can be mentioned that the expression “hard disk”, which is used throughout the text of this application, has the same meaning as the expression “hard disk drive”, which is also commonly used in the respective technical field.

1. Portable device (1) for processing data (D), the device (1) comprising
first memory means (2) provided for storing said data (D), said
first memory means (2) are arranged of being stopped providing said data (D) to be processed; and
second memory means (3) provided for storing at least a portion of said data (D), said second memory means (3) being arranged to provide said portion of said data (D) while the first memory means (2) are stopped providing said data (D); and
processing means (4) arranged to receive a stop signal (S) and arranged to stop the first memory means (2) providing said data (D) in response to the received stop signal (S) and arranged to process data (D) provided by the second memory means (3) while the first memory means (2) are stopped providing data (D); and
interface means (7) arranged to interface with a user for the purpose of receiving a first user command and to produce said stop signal (S) in response to the received first user command and to provide said produced stop signal (S) to the processing means (4).

2. Device (1) as claimed in claim 1, wherein the processing means (4) are arranged to copy a pre-determined portion of said data (D) from said first memory means (2) to said second memory means (3) before the first memory means (2) are stopped providing said data (D).

3. Device (1) as claimed in claim 1, wherein the processing means (4) are arranged to receive an activation signal (A) and are arranged to re-activate the first memory means (2) being stopped providing said data (D) for providing said data (D) in response to the received activation signal (A).

4. Device (1) as claimed in claim 3, wherein the interface means (7) are arranged to receive a second user command for producing said activation signal (A) in response to the received second user command and to provide said produced activation signal (A) to the processing means (4).

5. Device (1) as claimed in claim 1, wherein
the device (1) is designed for processing data (D) representing audio and/or video content.

6. Method of processing data (D) in a portable device (1), which device (1) comprises first memory means (2) and second memory means (3) for providing stored data (D), wherein said first memory means (2) are arranged of being stopped providing said data (D) to be processed, said method comprising the steps of
receiving a first user command by the aid of interface means (7) of the device (1), and
producing a stop signal (S) for stopping the first memory means (2) providing data (D) in response to the received user command, and providing said produced stop signal (S) to processing means (4) of the device (1), which processing means (4) are arranged to receive said stop signal (S) and to stop the first memory means (2) providing said data (D) in response to the received stop signal (S), and
processing the data (D) provided by the second memory means (3) with the processing means (4) while the first memory means (2) being stopped providing said data.

7. A method as claimed in claim 6, wherein the method further comprises the step of
copying with the aid of the processing means (4) a pre-determined portion of data (D) from said first memory means (2) to said second memory means (3) before the first memory means (2) are stopped providing said data (D).

8. A method as claimed in claim 6, wherein the method further comprises the steps of
receiving at the processing means (4) an activation signal (A) for activating the first memory means (2) being stopped providing said data (D), and
re-activating the first memory means (2) being stopped providing said data (D) for providing said data (D) by the aid of the processing means (4).

9. A method as claimed in claim 8, wherein the method further comprises the steps of
receiving a second user command by the aid of said interface means (7), and
producing said activation signal (A) in response to the received second user command, and
providing said produced activation signal (A) to said processing means (4).

10. A method as claimed in claim 6, wherein
the processed data represent audio and/or video data.
